(19) United States
(12) Patent Application Publication
(10) Pub. No.: US 2026/0222857 A1
(43) Pub. Date: Jul. 30, 2026

(54) APPARATUS, METHOD, AND COMPUTER PROGRAM

(71) Applicant: NOKIA TECHNOLOGIES OY, Espoo (FI)

(72) Inventors: Lars DALSGAARD, Oulu (FI); Jani-Pekka KAINULAINEN, Cottenham (GB); Riikka Karoliina DIMNIK, Kirkkonummi (FI); Tero HENTTONEN, Espoo (FI)

(21) Appl. No.: 19/159,065

(22) PCT Filed: Feb. 9, 2024
(86) PCT No.: PCT/EP2024/053275

§ 371 Date: Aug. 22, 2025

(30) Foreign Application Priority Data
Feb. 27, 2023 (GB) 2302855.8

(51) Int. Cl. H04W 24/08

(52) U.S. Cl. CPC H04W 24/08

(57) ABSTRACT

There is disclosed an apparatus comprising: means for storing a cell configuration for use when the apparatus is in an active mode; means for sending one or more cell measurements of a cell associated with the stored cell configuration to a network node; and means for, once the cell measurements have been sent, activating the stored cell configuration at the apparatus while the apparatus is in the active mode or is entering the active mode.

### FIELD

The present application relates to a method, apparatus, and computer program and in particular but not exclusively to apparatus, methods and computer programs for configuring cells.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to a first aspect there is provided an apparatus comprising: means for storing a cell configuration for use when the apparatus is in an active mode; means for sending one or more cell measurements of a cell associated with the stored cell configuration to a network node; and means for, once the cell measurements have been sent, activating the stored cell configuration at the apparatus while the apparatus is in the active mode or is entering the active mode.

According to some examples, the means for storing is configured to store the cell configuration while the apparatus is in an idle or inactive mode.

According to some examples the means for activating the stored cell configuration is arranged to autonomously activate the stored cell configuration.

According to some examples by autonomously activating the stored cell configuration is meant that the stored cell configuration is activated without an explicit command from the network.

According to some examples the apparatus comprises means for sending information of an activation time to the network node for the activating the stored cell configuration.

According to some examples, information of the activation time is comprised in one or more of: Downlink Control Information; Medium Access Control Control Element; a timer value.

According to some examples the apparatus comprises means for one or both of: performing the one or more cell measurements; evaluating the one or more cell measurements.

According to some examples the apparatus is configured to carry out the performing the one or more cell measurements or the evaluating the one or more cell measurements in response to receiving a conditional cell activation message from the network node.

According to some examples the apparatus comprises means for searching for available measurements for the cell from storage at the apparatus.

According to some examples the apparatus comprises means for receiving information from the network node indicating which resources to use when in the active mode.

According to some examples the apparatus comprises means for sending information of a channel index to the base station.

According to some examples the channel index comprises a reference signal index.

According to some examples, the reference signal index comprises one of: Synchronization Signal Block reference signal; Channel State Information reference signal.

According to some examples the activating the stored cell configuration is dependent on at least one threshold being met, the apparatus comprising means for checking whether the threshold has been met.

According to some examples the threshold comprises one of: Synchronization Signal Block Reference Signal Received Power; Synchronization Signal Block Reference Signal Received Quality.

According to some examples, the cell configuration comprises a Radio Resource Control configuration.

According to some examples the network node to which the one or more cell measurements are sent comprises a base station.

According to some examples the cell comprises one of: a Secondary Cell; a Primary Secondary Cell.

According to some examples the apparatus comprises a user equipment.

According to some examples the means comprises at least one processor; and at least one memory storing instructions that, when executed by the at least one processor, cause the performance of the apparatus.

According to a second aspect there is provided an apparatus comprising: at least one processor; and at least one memory storing instructions that, when executed by the at least one processor, cause the apparatus at least to perform: storing a cell configuration for use when the apparatus is in an active mode; sending one or more cell measurements of a cell associated with the stored cell configuration to a network node; and once the cell measurements have been sent, activating the stored cell configuration at the apparatus while the apparatus is in the active mode or is entering the active mode.

According to a third aspect there is provided an apparatus comprising: circuitry for storing a cell configuration for use when the apparatus is in an active mode; circuitry for sending one or more cell measurements of a cell associated with the stored cell configuration to a network node; and circuitry for, once the cell measurements have been sent, activating the stored cell configuration at the apparatus while the apparatus is in the active mode or is entering the active mode.

According to a fourth aspect there is provided a method comprising: storing a cell configuration for use when the apparatus is in an active mode; sending one or more cell measurements of a cell associated with the stored cell configuration to a network node; and once the cell measurements have been sent, activating the stored cell configuration at the apparatus while the apparatus is in the active mode or is entering the active mode.

According to some examples the method comprises storing the cell configuration while the apparatus is in an idle or inactive mode.

According to some examples the activating the stored cell configuration comprises autonomously activating the stored cell configuration.

According to some examples by autonomously activating the stored cell configuration is meant that the stored cell configuration is activated without an explicit command from the network.

According to some examples the method comprises sending information of an activation time to the network node for the activating the stored cell configuration.

According to some examples, information of the activation time is comprised in one or more of: Downlink Control Information; Medium Access Control Control Element; a timer value.

According to some examples the method comprises one or both of: performing the one or more cell measurements; evaluating the one or more cell measurements.

According to some examples the performing the one or more cell measurements or the evaluating the one or more cell measurements in response to receiving a conditional cell activation message from the network node.

According to some examples the method comprises searching for available measurements for the cell from storage at the apparatus.

According to some examples the method comprises receiving information from the network node indicating which resources to use when in the active mode.

According to some examples the method comprises sending information of a channel index to the base station.

According to some examples the channel index comprises a reference signal index.

According to some examples, the reference signal index comprises one of: Synchronization Signal Block reference signal; Channel State Information reference signal.

According to some examples the activating the stored cell configuration is dependent on at least one threshold being met, and the method comprises checking whether the threshold has been met.

According to some examples the threshold comprises one of: Synchronization Signal Block Reference Signal Received Power; Synchronization Signal Block Reference Signal Received Quality.

According to some examples, the cell configuration comprises a Radio Resource Control configuration.

According to some examples the network node to which the one or more cell measurements are sent comprises a base station.

According to some examples the cell comprises one of: a Secondary Cell; a Primary Secondary Cell.

According to some examples the apparatus comprises a user equipment.

According to a fifth aspect there is provided a computer program comprising instructions which, when executed by an apparatus, cause the apparatus to perform at least the following: storing a cell configuration for use when the apparatus is in an active mode; sending one or more cell measurements of a cell associated with the stored cell configuration to a network node; and once the cell measurements have been sent, activating the stored cell configuration at the apparatus while the apparatus is in the active mode or is entering the active mode.

According to a sixth aspect there is provided a computer program comprising instructions stored thereon for performing at least the following: storing a cell configuration for use when an apparatus is in an active mode; sending one or more cell measurements of a cell associated with the stored cell configuration to a network node; and once the cell measurements have been sent, activating the stored cell configuration at the apparatus while the apparatus is in the active mode or is entering the active mode.

According to a seventh aspect there is provided a non-transitory computer readable medium comprising program instructions that, when executed by an apparatus, cause the apparatus to perform at least the following: storing a cell configuration for use when the apparatus is in an active mode; sending one or more cell measurements of a cell associated with the stored cell configuration to a network node; and once the cell measurements have been sent, activating the stored cell configuration at the apparatus while the apparatus is in the active mode or is entering the active mode.

According to an eighth aspect there is provided a non-transitory computer readable medium comprising program instructions stored thereon for performing at least the following: storing a cell configuration for use when an apparatus is in an active mode; sending one or more cell measurements of a cell associated with the stored cell configuration to a network node; and once the cell measurements have been sent, activating the stored cell configuration at the apparatus while the apparatus is in the active mode or is entering the active mode.

According to a ninth aspect there is provided an apparatus comprising: means for allocating resources of a cell configuration to a user equipment; means for storing information of the allocated resources at the apparatus; and means for sending information of the allocated resources to the user equipment, for the user equipment to use when in an active mode or entering an active mode in the cell.

According to some examples the means for storing is configured to store information of the allocated resources while the user equipment is in an idle or inactive mode.

According to some examples the apparatus comprises means for receiving information of one or more cell measurements from the user equipment, and for associating those measurements with the cell.

According to some examples the apparatus comprises means for receiving information of a reference signal index from the user equipment.

According to some examples, the reference signal index comprises one of: Synchronization Signal Block reference signal; Channel State Information reference signal.

According to some examples, the apparatus comprises means for sending a conditional activation command to the user equipment, wherein a condition of the conditional activation command comprises a threshold value.

According to some examples the apparatus comprises means for sending a cell configuration deactivation command to the user equipment when the threshold is not met.

According to some examples the apparatus comprises a base station.

According to some examples the means comprises at least one processor; and at least one memory storing instructions that, when executed by the at least one processor, cause the performance of the apparatus.

According to a tenth aspect there is provided an apparatus comprising: at least one processor; and at least one memory storing instructions that, when executed by the at least one processor, cause the apparatus at least to perform: allocating resources of a cell configuration to a user equipment; storing information of the allocated resources at the apparatus; and sending information of the allocated resources to the user equipment, for the user equipment to use when in an active mode or entering an active mode in the cell.

According to an eleventh aspect there is provided an apparatus comprising: circuitry for allocating resources of a cell configuration to a user equipment; circuitry for storing information of the allocated resources at the apparatus; and circuitry for sending information of the allocated resources to the user equipment, for the user equipment to use when in an active mode or entering an active mode in the cell.

According to a twelfth aspect there is provided a method comprising: allocating resources of a cell configuration to a user equipment; storing information of the allocated resources at the apparatus; and sending information of the allocated resources to the user equipment, for the user equipment to use when in an active mode or entering an active mode in the cell.

According to some examples the method comprises storing information of the allocated resources while the user equipment is in an idle or inactive mode.

According to some examples the method comprises receiving information of one or more cell measurements from the user equipment, and associating those measurements with the cell.

According to some examples the method comprises receiving information of a reference signal index from the user equipment.

According to some examples, the reference signal index comprises one of: Synchronization Signal Block reference signal; Channel State Information reference signal.

According to some examples, the method comprises sending a conditional activation command to the user equipment, wherein a condition of the conditional activation command comprises a threshold value.

According to some examples the method comprises sending a cell configuration deactivation command to the user equipment when the threshold is not met.

According to some examples the apparatus comprises a base station.

According to a thirteenth aspect there is provided a computer program comprising instructions which, when executed by an apparatus, cause the apparatus to perform at least the following: allocating resources of a cell configuration to a user equipment; storing information of the allocated resources at the apparatus; and sending information of the allocated resources to the user equipment, for the user equipment to use when in an active mode or entering an active mode in the cell.

According to a fourteenth aspect there is provided a computer program comprising instructions stored thereon for performing at least the following: allocating resources of a cell configuration to a user equipment; storing information of the allocated resources at an apparatus; and sending information of the allocated resources to the user equipment, for the user equipment to use when in an active mode or entering an active mode in the cell.

According to a fifteenth aspect there is provided a non-transitory computer readable medium comprising program instructions that, when executed by an apparatus, cause the apparatus to perform at least the following: allocating resources of a cell configuration to a user equipment; storing information of the allocated resources at the apparatus; and sending information of the allocated resources to the user equipment, for the user equipment to use when in an active mode or entering an active mode in the cell.

According to a sixteenth aspect there is provided a non-transitory computer readable medium comprising program instructions stored thereon for performing at least the following: allocating resources of a cell configuration to a user equipment; storing information of the allocated resources at an apparatus; and sending information of the allocated resources to the user equipment, for the user equipment to use when in an active mode or entering an active mode in the cell.

### DESCRIPTION OF FIGURES

Embodiments will now be described, by way of example only, with reference to the accompanying Figures in which:

FIG. 1 shows a representation of a network system according to some example embodiments;

FIG. 2 shows an example of a network system according to some example embodiments;

FIG. 3 (which continues over two pages) is a signalling diagram according to an example embodiment;

FIG. 4 shows a schematic representation of a control apparatus according to some example embodiments;

FIG. 5 shows a schematic representation of a user terminal according to some example embodiments;

FIG. 6 is a flow chart of a method according to an example embodiment;

FIG. 7 is a flow chart of a method according to an example embodiment;

FIG. 8 shows a schematic representation of a non-volatile memory medium storing instructions which when executed by a processor allow a processor to perform one or more of the steps of the methods of some embodiments.

### DETAILED DESCRIPTION

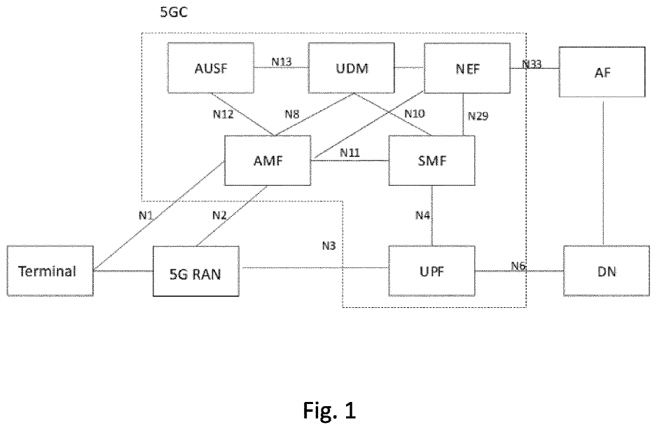

In the following, certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIG. 1 to assist in understanding the technology underlying the described examples.

FIG. 1 shows a schematic representation of a 5G system (5GS), which is provided by way of example of a communication system. The 5GS may comprise a terminal or user equipment (UE), a 5G radio access network (5GRAN) or next generation radio access network (NG-RAN), a 5G core network (5GC), one or more application function (AF) and one or more data networks.

The 5G-RAN may comprise one or more gNodeB (gNB) or one or more gNodeB (gNB) distributed unit functions connected to one or more gNodeB (gNB) centralized unit functions.

The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF). FIG. 1 also shows the various interfaces (N1, N2 etc.) that may be implemented between the various elements of the system.

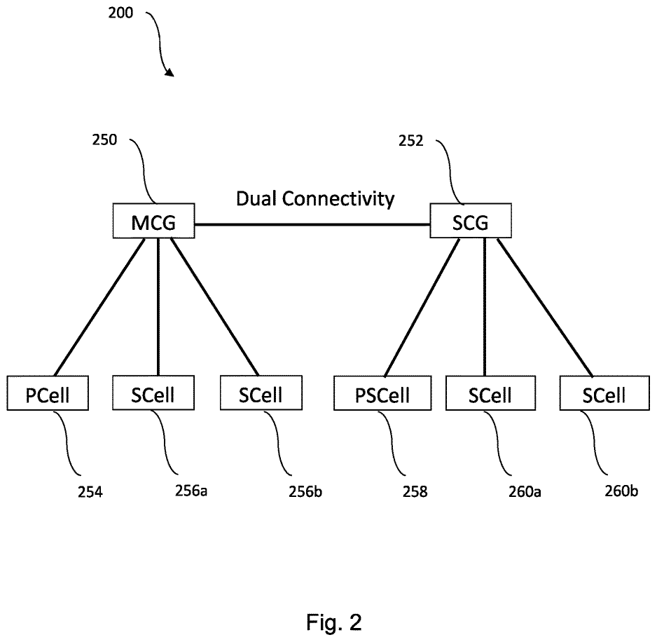

FIG. 2 shows a system 200 in which some examples may be performed. System 200 comprises Master Cell Group (MCG) 250 and a Secondary Cell Group (SCG) 252. System 200 may also comprise other SCGs, each having a PSCell. Each of the other SCGs may also have one or more SCells.

MCG 250 comprises a Primary Cell (PCell) 254. PCell 254 may be used to initiate initial access for a UE. MCG 250 may also comprise other cells comprising at least one Secondary Cell (SCell) 256a and 256b.

MCG 250 may be controlled by a Master Node (MN).

MCG 250 is connected to SCG 252 by a Dual Connectivity (DC) system. SCG 252 comprises a Primary Secondary Cell (PSCell) 258 which may be used as a cell for which initial access is initiated for SCG 252. SCG 252 may also comprise other cells comprising at least one Secondary Cell (SCell) 260a and 260b.

SCG 252 may be controlled by a Secondary Node (SN). Each SCG in system 200 may comprise a SN.

A UE can be in dual connectivity with a MN (wherein the MN may comprise a PCell) and a SN (wherein the SN may comprise a PSCell). Therefore, a UE in dual connectivity with a MN and SN may be configured with a corresponding PCell and PSCell. The MN or SN can initiate a Conditional Primary Secondary Cell Change (CPC) procedure.

3GPP has been working on improving the CA/DC (carrier aggregation/dual connectivity) setup delays in LTE and NR for a number of releases and the work has continued in Rel-18, including an objective for enhancing CA and/or DC setup delays with specific emphasis on improving the latencies for use of FR2 (Frequency Range 2) SCell(s) and/or PSCell.

During a Radio Resource Control (RRC) setup/resume procedure, a UE can perform validation of some available idle, inactive or connected mode measurements (on UE side) to check whether results are still usable. Measurement results can be used, for example, to represent received signal strength of candidate cells for carrier aggregation or dual connectivity, such as candidate SCell(s) or PSCell. Validation of such measurements, which may in some cases comprise additional measurements for validation purposes, may continue for a period of time after UE has entered connected mode (hence, during connected mode).

In some cases, it is feasible for UE implementation to have available measurements in an optimised manner when RRC setup/resume is triggered. Such UE would only need short or no additional time for measurement validation during setup/resume procedure, and such UE would be able to report validated results quickly.

Some UEs may also support storing the entire SCG or MCG SCell configuration while the UE is in an idle or Inactive mode. The network may configure the UE to store a configuration while the UE is in Inactive mode or Idle mode once the connection is being released. Based on that request, the UE will store the information while in Inactive or Idle mode. The network may then request UE to restore the stored configuration when entering connected mode again.

For the network to activate an SCell or PSCell which is a first cell in an FR2 band, there is a need for the network to “reach” the UE in terms of scheduling. One way to facilitate this is by knowing which downlink reference signal (DL RS) the UE will listen to.

Hence, to reduce the (P)SCell activation time (for example time to configure and possibly activate) there may be a benefit for an early enabling network to know where it can assume that the UE will listen to any potential scheduling occasions.

In the present disclosure a method is proposed where a UE conditionally activates a cell configuration. For example, the cell configuration may be an SCell configuration. In another example the cell configuration may be a PSCell configuration. In examples, the UE is configured to store the cell configuration which is to be activated. In examples the UE stores the cell configuration while the UE is in idle/inactive mode. Then, the UE activates the stored cell configuration when entering connected mode. In some examples, the UE is configured to send or report cell measurements to the network (e.g. gNB). For example the reported cell measurements could be Reference Signal Received Power (RSRP). Accompanying the cell measurements, the UE may also send an Index (indicating the Reference signal for the preferred DL beam). In examples the UE will activate the cell (e.g. SCell) associated with the stored cell configuration, once the necessary measurement results have been reported to the network. According to some examples, when a cell is activated it means that the UE will use the stored cell configuration and (i) actively start reception on that cell (monitor for scheduling), or (ii) wait for the network to send a final activation command (which triggers UE to start monitoring for scheduling). In some examples, activating a stored cell may occur without receiving an activation command from network side. That is, in some examples it may be considered that once the measurement results have been sent to the network, the UE autonomously activates the cell associated with the stored cell configuration. In some examples the UE applies the stored cell information but may wait for activation of the stored cell from the network.

In some examples the UE validates the cell measurements. In some examples, the manner of reporting the cell measurements by the UE may be based on, for example, network configuration, network request etc. (e.g. UEInformationRequest+UEInformationResponse).

In examples, a UE reports (validated) measurement results as part of this procedure (entering connected mode for example from inactive mode), and the UE includes SSB Index as part of the results if at least one of the following applies:
the network has indicated ‘SCell activation’ when configuring the stored SCell parameters.
the network indicates ‘SCell activation’ in the RRCResume message
the network indicates ‘Scell activation’ in a broadcast message (e.g., SIB)

In some examples, the “SCell activation” may also apply for a stored PSCell configuration, either explicitly (e.g. separate indication for SCells and PSCell) or implicitly (one indication triggers both SCell and PSCell restoration). As mentioned above, in some examples the UE will activate the stored SCell once the measurement results have been reported, without further SCell activation command from network side. In some examples the SCell activation time is based on the time when UE sent the measurement results. In some examples a time offset is used, so that cell activation occurs a certain time after the measurements have been sent. In another example, the UE may be indicated the SCell activation time via Downlink Control Information (DCI), Medium Access Control Control Element (MAC CE), or via timer value within an RRC message containing the reported results.

In some examples, the cell activation is conditional, so that the cell is activated when one or more conditions is met. In some examples, the condition relates to a defined threshold. For example, the defined threshold could be reference signal based. For example, the threshold could be SSB-RSRP (Synchronization Signal and PBCH Block Reference Signal Received Power) based, SSB-RSRQ (Synchronization Signal and PBCH Block Reference Signal Received Quality) based or another measurement metric. In another example, other reference signals could be used such as CSI-RS. In an example, the stored cell (e.g. SCell) is activated only if the threshold condition is fulfilled. In an example, the stored cell (e.g. SCell) is not activated if the threshold condition is not fulfilled. Such threshold could be network configured.

In some examples, the network (e.g. gNB) can ‘cancel’ or deactivate a conditional cell activation by sending a cell deactivation command to the UE after receiving the measurement results, or by explicit indication such as an RRC message (e.g. in an RRCResume message). In one alternative, the conditional activation is not executed if the network does not request and/or receive the measurement results. In another example, the conditional activation is conditioned on a final activation command or confirmation from the network.

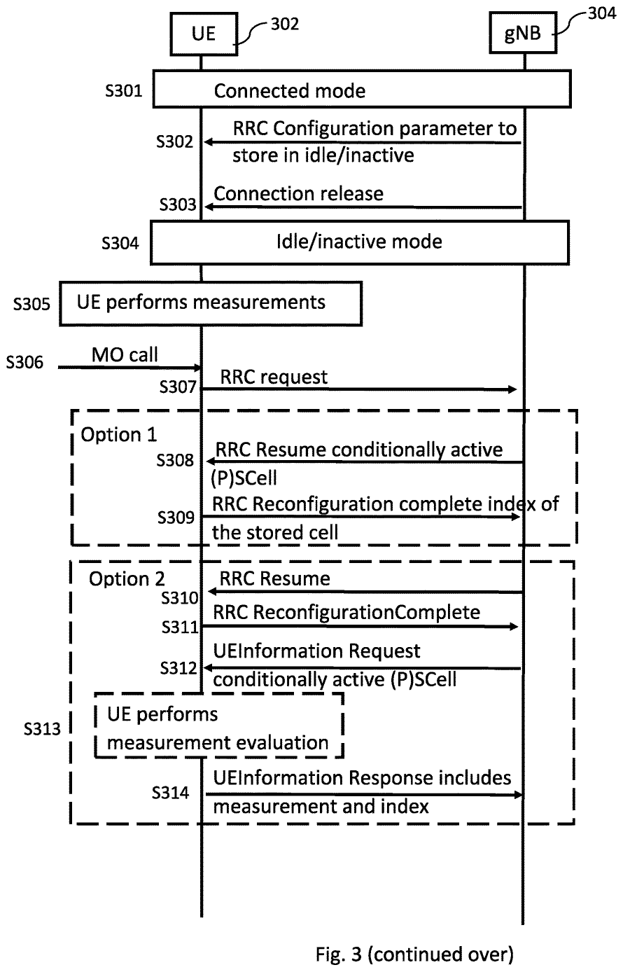

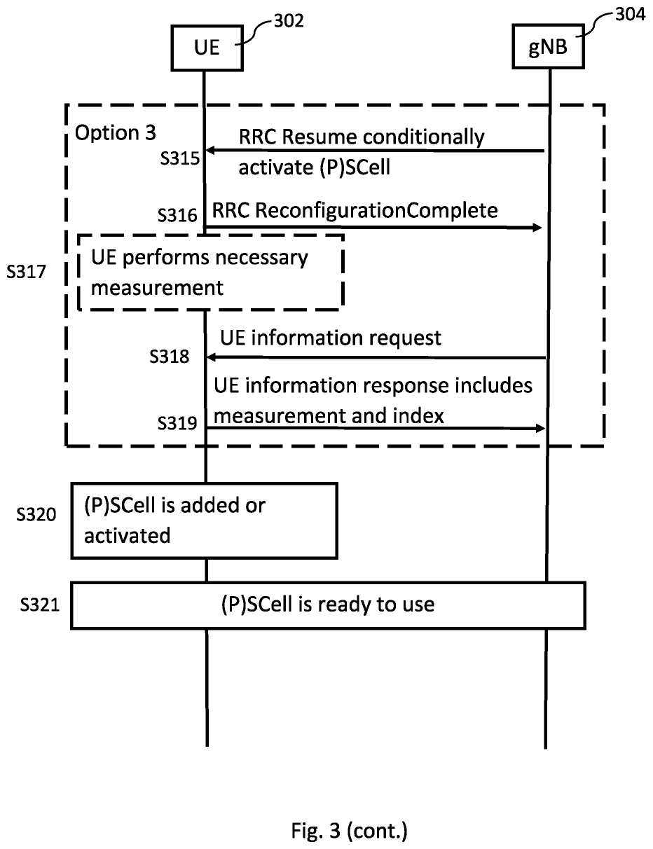

FIG. 3 (which is split over two pages) is a signaling diagram which helps to explain in more detail how some examples may be implemented. The signaling diagram shows communication between a UE 302 and a gNB 304. The context of FIG. 3 is 5G (NR), but this is by way of non-limiting example, and the examples can also be applied in other technologies such as LTE and 6G. Furthermore, the context of FIG. 3 is a scenario where the network has configured the UE to store an SCell configuration while in inactive mode. However, in another example the context may be PSCell configuration. Also, the method is not limited to inactive mode but may also be used with other modes. In examples, when the UE connection is released and the UE enters inactive mode, the UE will perform any necessary measurements. FIG. 3 also provides some alternative options (“Option 1”, “Option 2”, and “Option 3”) for communication between the UE 302 and the gNB 304, before the cell is added or activated.

As shown at S301, the UE is initially in a connected mode with gNB 304. For example, the UE may be operating in carrier aggregation (CA). During the connected mode the network configures the UE such that the UE will store for example an SCell configuration in inactive mode. For example, the gNB 304 may send a message to the UE 302 to store a cell configuration and/or parameters of a cell configuration while the UE is idle or inactive. In some examples, this information is sent in an RRC configuration message, as shown at S302. The information sent at S302 may include an “activate” indication for PSCell or SCell configuration. The indication may indicate when or under what conditions to activate the PSCell or SCell. In some examples, the indication can indicate the activation conditions directly, or alternatively as a reference to a previously stored configuration. The UE 302 then stores the received configuration.

As shown at S303, the gNB 304 then sends a connection release message.

This causes the UE 302 to be placed in the idle or inactive mode, as shown at S304.

At S305, the UE performs cell measurements, while it is in the idle/inactive mode. For example these may be measurements of reference signals.

At some point, and as shown at S306 as an example, a mobile originated (MO) call is established.

After this, a connection setup procedure is initiated. For example, the connection setup may be initiated with an RRC Request message, as shown at S307.

Once the RRC request has been sent to gNB 304 at S307, three alternative options are discussed for how the UE 302 and gNB 304 may communicate before the stored cell is added. These three options are schematically shown in the dashed boxes in FIG. 3 labelled Option 1, Option 2, and Option 3.

Option 1 begins at S308, where a conditional activation message is received at UE 302 from gNB 304. For example, this conditional message may be comprised in an RRC Resume message, which contains information to conditionally activate (P)SCell. Some alternatives of how the UE 302 stores the information are envisaged. Three non-limiting alternative examples are described below.
i. In one alternative, the stored cell configuration (e.g. SCell configuration) may include an indication whether the UE should conditionally activate the stored cell when entering connected mode (if or when conditions are fulfilled). In this scenario the RRCResume message may not include the conditional activation indication in order for the UE to conditionally activate the stored SCell.
ii. In one alternative, the stored cell configuration (e.g. SCell configuration) may include an indication whether the UE may be requested to conditionally activate the stored cell when entering connected mode (if or when conditions are fulfilled). In this scenario the RRCResume message may or may not include the conditional activation indication. If the indication is included, it means that the UE should conditionally activate the stored cell. If the indication is not included, it means that the UE should not conditionally activate the stored cell.
iii. In another alternative, the stored information does not include information or an indication of whether the cell should be conditionally activated when entering connected mode. This indication is instead only indicated in the signaling when entering connected mode, for example in the RRCResume message or another activation command or request message.

Whichever of alternatives (i) to (iii) is used, the method proceeds to S309. If the conditions for activating the stored cell are fulfilled, the UE 302 sends an indication to the gNB 304. For example, the indication may comprise an RRC Reconfiguration complete message. In some examples, the UE 302 includes further information in the message at S309. For example, the further information may comprise one or more indexes. For example, the one or more indexes may comprise an SSB-index. In some examples, the SSB Index refers to DL reference signal reference or identifier. The SSB index can be used to identify the cell. Also, the UE 302 can perform measurements on that index.

Hereafter, the UE activates the cell in S320 (when any necessary conditions are fulfilled), and the cell (e.g. SCell) is ready to use as shown at S321.

In Option 2, UE 302 receives an RRC Resume message from gNB 304 at S310.

UE 302 sends a RRC Reconfiguration Complete message to gNB 304 at S311.

A cell (e.g. SCell) conditional activation indication is received at the UE 302, as shown at S312. In this example, the conditional activation indication is received in a UE Information Request message. In some examples the UE Information Request message comprises a request for measurements from the UE.

If the UEInformationRequest message includes an indication to conditionally activate the stored cell, the UE will initiate this. Hence, the UE will evaluate if the conditions for activating the cell are fulfilled, as shown at S313. More specifically, the UE 302 may perform measurements in the cell and then use those measurements to establish whether conditions are fulfilled for activating the cell.

At S314, the UE replies to the request with the outcome of the evaluation. Hence, if the UE evaluated that the conditions for activating the cell are fulfilled, the UE includes information in a response message. For example, the UE 302 may include the measurement information in the response. In some examples the UE 302 may also include an index in the response, such as an SSB Index. The response message may comprise a UEInformationResponse message. The network (e.g. gNB 304) would then, (i) know the stored cell cell-conditions and (ii) the network (e.g. gNB 304) would know which DL reference signal is preferred by the UE (which indicates which DL beam/spatial direction) the network should use.

Hereafter, the UE activates the cell in S320 (if the results and Index for the stored cell were included in the response), and the cell is ready to use as shown at S321.

In Option 3, as shown at S315, the UE receives an indication to conditionally activate a cell (e.g. SCell). This may be received in an RRC Resume message.

At S316, the UE 302 replies with an RRC Reconfiguration complete message.

At S317, the UE evaluates the conditions for activation of the cell. If there is a need for further actions on UE side to fulfil these conditions or for UE to be able to evaluate if the conditions are fulfilled (for example perform one or more measurements), the UE 302 will perform these measurements in S317. Hence, in S317 it may be considered that the UE performs actions related to fulfilling the conditions for activating the cell.

At S318, the network requests measurement results from the UE 302. For example, the gNB 304 requests the information using a UEInformationRequest message.

At S319, the UE responds with an information response message. For example, the information response message includes the measurements performed at S317. Additionally, the response at S319 may include index information for the cell, such as SSB index information, if the conditions for activating the cell are fulfilled.

Hereafter, the UE activates the cell in S320 (if the results and Index for the stored cell were included in the response), and the cell is ready to use as shown at S321.

In some examples (whether Option 2 or Option 3), the network (e.g. gNB 304) may send more than one UEInformationRequest to the UE 302 to request measurement results. In this case, the UE may respond with more than one UEInformationResponse.

A benefit of the disclosed examples is that when a UE has measurements available from the idle-mode (whose validity may be checked by the UE in some examples), and the network knows which cell (e.g. (P)SCell) the measurements are associated to, the network is able to configure or activate the cell quickly without receiving the measurement results via UEInformationRequest. In examples, this allows the activation delay to be very short. For example the activation delay could be around 20 ms. Currently, UEs are not required to store any existing measurements beyond T331 timer expiration, and a UE needs to transmit measurements requested by UEInformationRequest after security has been established.

In other words, a benefit is that the UE and the network are able to create associations of SCell measurements with fewer measurements and in less time than it would need in legacy methods. This means significant reduction to the CA or DC setup time. When compared to the current rel-16 based EMR framework, the network needs to request measurements from the UE after security has been established.

Therefore, examples of the present disclosure can significantly shorten this delay for cell activation.

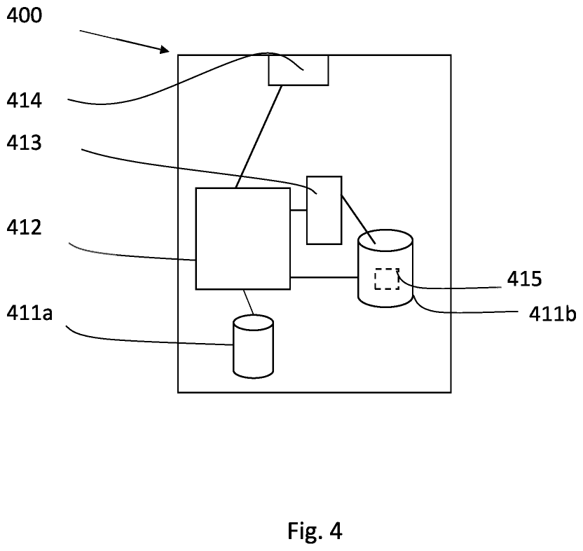

FIG. 4 illustrates an example of a control apparatus 400 for controlling a function of the 5GRAN or the 5GC as illustrated on FIG. 1. The control apparatus may comprise at least one random access memory (RAM) 411a, at least one read only memory (ROM) 411b, at least one processor 412, 413 and an input/output interface 414. The at least one processor 412, 413 may be coupled to the RAM 411a and the ROM 411b. The at least one processor 412, 413 may be configured to execute an appropriate software code 415. The software code 415 may for example allow to perform one or more steps to perform one or more of the present aspects. The software code 415 may be stored in the ROM 411b. The control apparatus 400 may be interconnected with another control apparatus 400 controlling another function of the 5GRAN or the 5GC. In some embodiments, each function of the 5GRAN or the 5GC comprises a control apparatus 400. In alternative embodiments, two or more functions of the 5GRAN or the 5GC may share a control apparatus. In some examples, the gNB 304 shown in FIG. 3 may be in the form of a control apparatus 400.

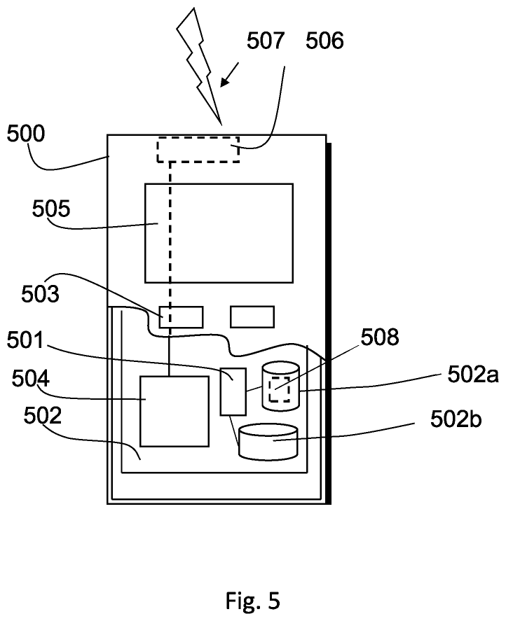

FIG. 5 illustrates an example of a terminal 500, such as the terminal illustrated on FIG. 1. The terminal 500 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 500 may provide, for example, communication of data for carrying communications. The communications may be one or more of voice, electronic mail (email), text message, multimedia, data, machine data and so on.

The terminal 500 may be provided with at least one processor 501, at least one memory ROM 502a, at least one RAM 502b and other possible components 503 for use in software and hardware aided execution of tasks it is designed to perform, including control of access to and communications with access systems and other communication devices. The at least one processor 501 is coupled to the RAM 502b and the ROM 502a. The at least one processor 501 may be configured to execute an appropriate software code 508. The software code 508 may for example allow to perform one or more of the present aspects. The software code 508 may be stored in the ROM 502a.

The processor, storage and other relevant control apparatus can be provided on an appropriate circuit board and/or in chipsets. This feature is denoted by reference 504. The device may optionally have a user interface such as key pad 505, touch sensitive screen or pad, combinations thereof or the like. Optionally one or more of a display, a speaker and a microphone may be provided depending on the type of the device.

The terminal 500 may receive signals over an air or radio interface 507 via appropriate apparatus for receiving and may transmit signals via appropriate apparatus for transmitting radio signals. In FIG. 5 transceiver apparatus is designated schematically by block 506. The transceiver apparatus 506 may be provided for example by means of a radio part and associated antenna arrangement. The antenna arrangement may be arranged internally or externally to the mobile device.

The UE 302 shown in FIG. 3 may be in the form of a user terminal 500.

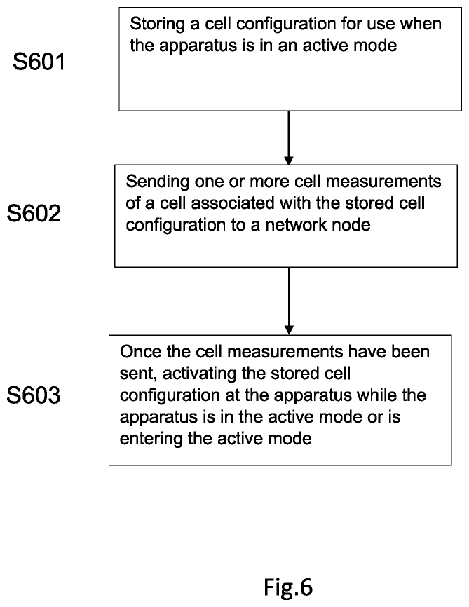

FIG. 6 is a flow chart of a method according to an example. The flow chart of FIG. 9 is viewed from the perspective of an apparatus. For example, the apparatus may comprise a user equipment

As shown at S601, the method comprises storing a cell configuration for use when the apparatus is in an active mode.

At S602, the method comprises sending one or more cell measurements of a cell associated with the stored cell configuration to a network node.

At S603 the method comprises, once the cell measurements have been sent, activating the stored cell configuration at the apparatus while the apparatus is in the active mode or is entering the active mode.

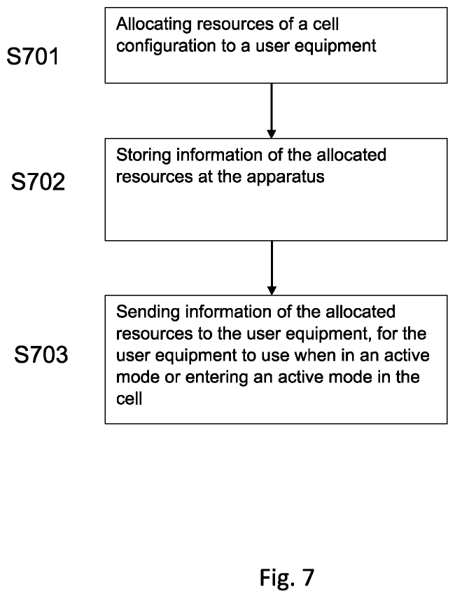

FIG. 7 is a flow chart of a method according to an example. The flow chart of FIG. 7 is viewed from the perspective of an apparatus. For example, the apparatus may comprise a base station (gNB).

As shown at S701, the method comprises allocating resources of a cell configuration to a user equipment.

At S702, the method comprises storing information of the allocated resources at the apparatus.

At S703, the method comprises sending information of the allocated resources to the user equipment, for the user equipment to use when in an active mode or entering an active mode in the cell.

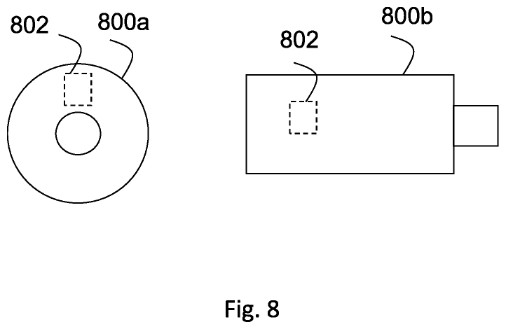

FIG. 8 shows a schematic representation of non-volatile memory media 800a (e.g. computer disc (CD) or digital versatile disc (DVD)) and 800b (e.g. universal serial bus (USB) memory stick) storing instructions and/or parameters 802 which when executed by a processor allow the processor to perform one or more of the steps of the method of FIG. 6 or 7.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising at least one processor and at least one memory including computer code for one or more programs, the at least one memory and the computer code being configured with the at least one processor, as to cause the apparatus at least to:
store a cell configuration for use when the apparatus is in an active mode;
send one or more cell measurements of a cell associated with the stored cell configuration to a network node; and
once the cell measurements have been sent, activate the stored cell configuration at the apparatus while the apparatus is in the active mode or is entering the active mode.

2. An apparatus according to claim 1, wherein the apparatus is configured to store the cell configuration while the apparatus is in an idle or inactive mode.

3. An apparatus according to claim 1, wherein the apparatus is configured to autonomously activate the stored cell configuration.

4. An apparatus according claim 1, wherein the apparatus is configured to at least one of perform the one or more cell measurements or evaluate the one or more cell measurements.

5. An apparatus according to claim 4, wherein the apparatus is configured to carry out the performing the one or more cell measurements or the evaluating the one or more cell measurements in response to receiving a conditional cell activation message from the network node.

6. An apparatus according to claim 1, wherein the apparatus is configured to search for available measurements for the cell from storage at the apparatus.

7. An apparatus according to claim 1, wherein the apparatus is configured to receive information from the network node indicating which resources to use when in the active mode.

8. An apparatus according to claim 1, wherein the apparatus is configured to send information of a channel index to the base station.

9. An apparatus according to claim 7, wherein the channel index comprises a reference signal index.

10. An apparatus according to claim 1, wherein the apparatus is caused to activate the stored cell configuration dependent on at least one threshold being met, and the apparatus is configured to check whether the threshold has been met.

11. An apparatus according to claim 10, wherein the threshold comprises one of: Synchronization Signal Block Reference Signal Received Power; Synchronization Signal Block Reference Signal Received Quality.

12. An apparatus according to claim 1, wherein the network node to which the one or more cell measurements are sent comprises a base station.

13. An apparatus according to claim 1, wherein the cell comprises one of: a Secondary Cell; a Primary Secondary Cell.

14. An apparatus according to claim 1, wherein the apparatus comprises a user equipment.

15. An apparatus comprising at least one processor and at least one memory including computer code for one or more programs, the at least one memory and the computer code being configured with the at least one processor to cause the apparatus at least to:
allocate resources of a cell configuration to a user equipment;
store information of the allocated resources at the apparatus; and
send information of the allocated resources to the user equipment, for the user equipment to use when in an active mode or entering an active mode in the cell.

16. An apparatus according to claim 15, wherein the apparatus is configured to store information of the allocated resources while the user equipment is in an idle or inactive mode.

17. An apparatus according to claim 15, wherein the apparatus is configured to receive information of one or more cell measurements from the user equipment, and to associate those measurements with the cell.

18. An apparatus according to claim 15, wherein the apparatus is configured to receive information of a reference signal index from the user equipment.

19. An apparatus according to claim 15, wherein the apparatus is configured to send a conditional activation command to the user equipment, wherein a condition of the conditional activation command comprises a threshold value.

20. An apparatus according to claim 19, wherein the apparatus is configured to send a cell configuration deactivation command to the user equipment when the threshold is not met.

21. An apparatus according to claim 15, wherein the apparatus comprises a base station.

22. A method comprising:
storing a cell configuration for use when the apparatus is in an active mode;
sending one or more cell measurements of a cell associated with the stored cell configuration to a network node; and
once the cell measurements have been sent, activating the stored cell configuration at the apparatus while the apparatus is in the active mode or is entering the active mode.

23. A method comprising:
allocating resources of a cell configuration to a user equipment;
storing information of the allocated resources at the apparatus; and
sending information of the allocated resources to the user equipment, for the user equipment to use when in an active mode or entering an active mode in the cell.

24. (canceled)

25. (canceled)
